(19) United States
(12) Patent Application Publication
(10) Pub. No.: US 2012/0227853 A1
(43) Pub. Date: Sep. 13, 2012

(54) FLOW- OPTIMIZED FLUID LINE

(75) Inventor: Andreas BAUER, Obernburg (DE)

(73) Assignee: NORMA GERMANY GMBH, Maintal (DE)

(21) Appl. No.: 13/408,650

(22) Filed: Feb. 29, 2012

(30) Foreign Application Priority Data
Mar. 10, 2011 (DE) 102011013572.3

(51) Int. Cl. F16L 9/00; B29C 47/00; B29C 69/02; B23P 17/00

(52) U.S. Cl. 138/177; 29/592; 264/209.3

(57) ABSTRACT

Fluid line and method of forming the fluid line. The fluid line includes a cylindrical inner surface having uniformly distributed recesses in the form of spherical sectors formed in the inner surface.

### CROSS-REFERENCE TO RELATED APPLICATIONS

The present application claims priority under 35 U.S.C. §119(a) of German Patent Application No. 10 2011 013 572.3, filed on Mar. 10, 2011, the disclosure of which is expressly incorporated by reference herein in its entirety

### BACKGROUND OF THE INVENTION

1. Field of the Invention

Embodiments of the invention relate to a fluid line with a cylindrical inner surface.

2. Discussion of Background Information

Fluid lines are used in many fields of application for conveying fluids, in particular liquids. Due to friction and turbulences losses thereby occur, which can lead to a deterioration of an overall degree of effectiveness of an installation. In particular in the case of smooth pipes, and in the smooth regions of partially corrugated pipes, the really usable flow cross section is often much smaller than the free inner cross section in the fluid line, since a quasi-stationary boundary layer forms in the edge region.

It is now known to provide fluid lines with particularly low-flow coatings. However, this is relatively complex and thus makes a production process more expensive. Also coatings of this type are not resistant to all fluids, so that the possibilities of use are limited.

### SUMMARY OF THE INVENTION

Embodiments of the invention are therefore to keep flow losses low.

According to the embodiments, a fluid line of the type mentioned at the outset includes uniformly distributed recesses in the form of spherical sectors that are embodied or formed in the inner surface of the fluid line.

The formation of a quasi-stationary boundary layer of the fluid flowing through the fluid line is prevented by these recesses. Instead turbulences are introduced in a targeted manner. A flow resistance and flow losses occurring therewith are thereby reduced. The real flow cross section approaches the actually free inner cross section. Overall, a lower-loss transfer is achieved in this manner. The inner surface can be embodied or formed as a circular cylindrical inner surface, that is, it can have a circular cross section. However, other embodiments, for example, with a polygonal or elliptical cross section, are also possible.

Preferably, the recesses have an identical radius of curvature. The recesses are thus all embodied or formed identically. This results in a very uniform flow.

Preferably, radial center points of the recesses lie on a cylindrical surface, the axis of symmetry of which coincides with an axis of symmetry of the inner surface. In this manner, a sum of radius of curvature and a radius of the cylindrical surface is larger than an inner radius of the inner surface. The cylindrical surface is thereby a notional surface, which is embodied or formed parallel to the inner surface. The recesses are all embodied or formed identically by an approach of this type, that is, they have the same depth and the same radius. A uniform embodiment of this type represents a simplification for the production of the fluid line.

It is particularly preferred that the radius of the cylindrical surface is more than 50% of the inner radius, and, in particular, the radius is less than 60% of the inner radius. The depth of the recesses is also determined by the radius of the cylindrical surface. The embodiment of relatively flat recesses is ensured by a radius that is between 50% and 60% of the inner radius, in particular 55% of the inner radius. A flow cross section is optimized thereby.

Advantageously, the radius of curvature is more than 50% of the inner radius, and, in particular, the radius of curvature is less than 55% of the inner radius. The radius of curvature of the recesses is therefore relatively large. This ensures that the recesses extend relatively flat from the inner surface, so that larger edges are avoided there, which in turn would lead to flow losses.

Preferably, four to eight recesses, in particular six recesses, are arranged at an identical axial position uniformly distributed next to one another in the circumferential direction. Such a number of recesses in the circumferential direction is already sufficient to prevent the development of a stationary boundary layer.

It is particularly preferred that axially adjacent recesses in the circumferential direction are offset with respect to one another. Axially adjacent recesses are disposed in a staggered manner relative to one another. A relatively large number of recesses per unit area can thus be accommodated. Also a very uniform distribution of the recesses results thereby, which in turn optimizes the flow course.

Preferably, a distance in the axial direction between the center points of adjacent recesses corresponds to the radius of curvature ±10%. This ensures that between the individual recesses, sufficient smooth inner surface is still available, which is used for the actual guidance of the fluid. At the same time it is ensured that a material of the fluid line is not unnecessarily thinned, that therefore the mechanical stability of the fluid line is maintained.

Preferably, the fluid line is embodied or formed as an extruded plastic tube, in particular as an extruded polyamide tube. A fluid line of this type has a high chemical resistance and at the same time is relatively stable. It can also be produced in a very cost-effective manner. The insertion of recesses is no problem either in the case of the extrusion process.

Embodiments of the invention are directed to a fluid line including a cylindrical inner surface having uniformly distributed recesses in the form of spherical sectors formed in the inner surface.

According to the embodiments, the recesses can have identical radii of curvature.

In accordance with other embodiments of the invention, radial center points of the recesses may subtend a cylinder having an axis of symmetry that coincides with an axis of symmetry of the inner surface. A sum of a radius of curvature of a recess and a radius of the cylinder is greater than an inner radius of the inner surface. The radius of the cylinder may be more than 50% of the inner radius. Further, the radius of the cylinder may be less than 60% of the inner radius. Moreover, the radius of curvature of a recess can be more than 50% of the inner radius, and the radius of curvature can be less than 55% of the inner radius.

According to still other embodiments, four to eight recesses may be arranged at a same axial position and uniformly distributed in a circumferential direction. More particularly, six recesses may be arranged at a same axial position and can be uniformly distributed in a circumferential direction.

In accordance with other embodiments of the invention, axially adjacent recesses can be offset with respect to one another in a circumferential direction.

According to embodiments, a distance between center points of adjacent recesses in an axial direction corresponds to the radius of curvature ±10%.

According to other embodiments, the fluid line may be formed as an extruded plastic tube. More particularly, the fluid line can be an extruded polyamide tube.

Embodiments of the instant invention are directed to a method of forming a fluid line. The method includes forming a tube having an inner radius, and forming a plurality of recesses on a surface of the inner radius having radii of curvature lying on an imaginary cylinder within the inner radius. The plurality of recesses can be formed at a same axial position and are uniformly distributed in a circumferential direction.

In accordance with still yet other embodiments of the present invention, the radii of curvature can be more than 50% of the inner radius and a radius of the imaginary cylinder is more than 50% of the inner radius. Further, the forming of the tube comprises extruding a plastic tube, and in particular, a polyamide tube. Moreover, the radii of curvature can be less than 55% of the inner radius and the radius of the imaginary cylinder may be less than 60% of the inner radius.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a section of a fluid line and

FIG. 2 illustrates the section from FIG. 1 in sectional side view.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

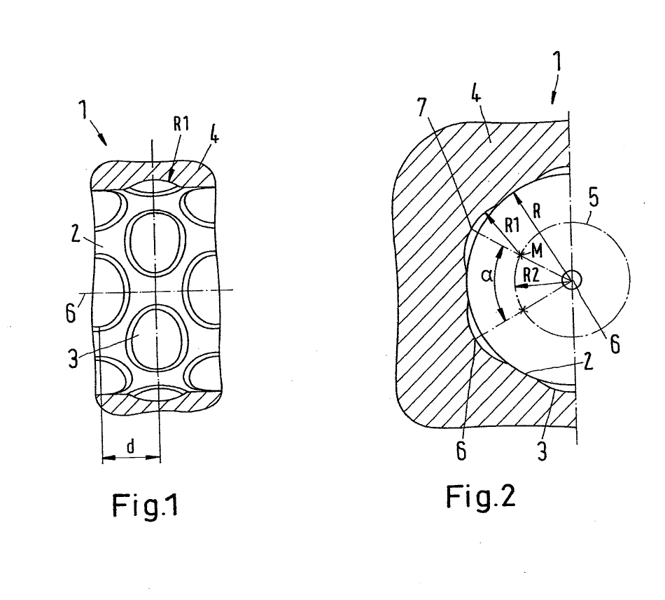

FIG. 1 shows a partial section of a fluid line 1, wherein the fluid line 1 is shown in longitudinal section so that an inner surface 2 of fluid line 1 can be seen. Recesses 3 are shaped and uniformly distributed in inner surface 2. Inner surface 2 is otherwise provided with a smooth surface.

Recesses 3 represent partial sphere-shaped shapes in a wall of fluid line 1. Recesses 3, which are arranged at an identical axial position, are thereby arranged on a circular path and at identical distances from one another in the circumferential direction. Axially adjacent recesses 3 are arranged offset to one another so that adjacent recesses 3 are positioned in each case staggered with respect to one another.

Inner surface 2 thus corresponds as it were to a surface of a golf ball. A surface of this type reduces the formation of a quasi-stationary boundary layer. A flow-optimized inner surface is thus produced with a low flow resistance and thus low flow losses.

FIG. 2 shows fluid line 1 from FIG. 1 in cross section. An inner cross section with an inner radius R is essentially circular. The circular form is interrupted only by recesses 3. Otherwise, inner surface 2 is embodied or formed in a smooth manner. Recesses 3 have a radius of curvature R1, which corresponds to approximately 55% of inner radius R. Radii of curvature of recesses 3 originate from center points M of notational spheres that subtend or lie on a notional (imaginary) cylinder 5 that runs parallel to inner surface 2. Notional cylinder 5 and the inner surface 2 thus have an identical axis of symmetry 6, which in the representation in FIG. 2 runs into the drawing plane. A radius R2 of notional cylinder 5 is thereby larger than 50% of inner radius R. In the illustrated embodiment, radius R2 of notional cylinder 5 accounts for 55% of inner radius R.

In this example, a total of six recesses 3 are provided, which are uniformly distributed in the circumferential direction. An angle α between two centers 6, 7 in the radial direction of adjacent recesses 3 therefore in this example is 60°.

As is discernible from FIG. 1, an axial distance d between adjacent center points M is smaller than a diameter of recesses 3. Recesses 3 therefore project in each case into gaps of adjacent recesses. In the present example, the distance is somewhat more than radius of curvature R1.

The sum of radius of curvature R1 and radius R2 of notional cylinder 5 is greater than inner radius R. Radius of curvature R1 and radius R2 of notional cylindrical surface 5 can thereby be of equal size, however, it can also be advantageous to select radius R2 of notional cylinder 5 to be somewhat larger, so that very flat recesses 3 are then obtained.

Embodiments are suitable for fluid lines with different diameters. A use with fluid lines with a diameter between 5 and 30 mm, in particular between 10 and 20 mm, is preferred.

Compared to smooth-walled tubes, that is, fluid lines that have a circular inner cross section with a smooth inner surface, a reduction of the flow resistance and thus of flow losses results due to the provision of the recesses, all of which are embodied or formed the same and are distributed uniformly over the inner surface of the fluid line. A forming boundary layer between the flowing fluid, in particular a liquid, and the inner surface of the fluid line is thereby reduced. In this way, the real flow cross section approximates the actual cross section. Overall in this manner a fluid line with lower flow losses is obtained.

Only a fluid line with circular cross section is shown in the example. Other embodiments, for example, with a polygonal or oval cross section, are likewise possible. The length of a radius then corresponds to a distance from the axis of symmetry. The word “radius” is therefore not to be understood in the narrow sense, but more generally as the definition of a distance from the axis of symmetry.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A fluid line comprising:
a cylindrical inner surface having uniformly distributed recesses in the form of spherical sectors formed in the inner surface.

2. The fluid line according to claim 1, wherein the recesses have identical radii of curvature.

3. The fluid line according to claim 1, wherein radial center points of the recesses subtend a cylinder having an axis of symmetry that coincides with an axis of symmetry of the inner surface.

4. The fluid line according to claim 3, wherein a sum of a radius of curvature of a recess and a radius of the cylinder is greater than an inner radius of the inner surface.

5. The fluid line according to claim 3, wherein the radius of the cylinder is more than 50% of the inner radius.

6. The fluid line according to claim 5, wherein the radius of the cylinder is less than 60% of the inner radius.

7. The fluid line according to claim 3, wherein the radius of curvature of a recess is more than 50% of the inner radius.

8. The fluid line according to claim 7, wherein the radius of curvature is less than 55% of the inner radius.

9. The fluid line according to claim 1, wherein four to eight recesses are arranged at a same axial position and are uniformly distributed in a circumferential direction.

10. The fluid line according to claim 9, wherein six recesses are arranged at a same axial position and are uniformly distributed in a circumferential direction.

11. The fluid line according to claim 1, wherein axially adjacent recesses are offset with respect to one another in a circumferential direction.

12. The fluid line according to claim 1, wherein a distance between center points of adjacent recesses in an axial direction corresponds to the radius of curvature ±10%.

13. The fluid line according to claim 1 being formed as an extruded plastic tube.

14. The fluid line according to claim 13 being an extruded polyamide tube.

15. A method of forming a fluid line, comprising:
forming a tube having an inner radius; and
forming a plurality of recesses on a surface of the inner radius having radii of curvature lying on an imaginary cylinder within the inner radius,
wherein the plurality of recesses is formed at a same axial position and is uniformly distributed in a circumferential direction.

16. The method of claim 15, wherein the radii of curvature are more than 50% of the inner radius.

17. The method of claim 16, wherein a radius of the imaginary cylinder is more than 50% of the inner radius.

18. The method of claim 17, wherein the forming of the tube comprises extruding a plastic tube.

19. The method of claim 18, wherein the plastic comprises polyamide.

20. The method of claim 18, wherein the radii of curvature are less than 55% of the inner radius and the radius of the imaginary cylinder is less than 60% of the inner radius.
